(19) United States
(12) Patent Application Publication
(10) Pub. No.: US 2018/0152307 A1
(43) Pub. Date: May 31, 2018

(54) DEVICE TO PROVIDE TRUSTED TIME ASSURANCE

(71) Applicant: QUALCOMM Incorporated, San Diego, CA (US)

(72) Inventors: Ashish Grover, Carlsbad, CA (US); Bollapragada Manohar, San Diego, CA (US); Baranidharan Mutukumaran, San Diego, CA (US); Zhen Kong, San Diego, CA (US)

(21) Appl. No.: 15/364,078

(22) Filed: Nov. 29, 2016

(51) Int. Cl. H04L 9/32; H04L 29/06

(52) U.S. Cl. CPC H04L 9/3297; H04L 9/3247; H04L 63/061; H04L 63/0435

(57) ABSTRACT

Aspects may relate to a device to provide trusted time assurance. The device may comprise: a time clock; an interface; and a processor coupled to the interface. The processor may be configured to operate a trusted execution environment to: receive a request through the interface from a server to send current time; receive a nonce from the server through the interface; sign the current time from the time clock, the nonce received from the server, and device information with an attestation key; transmit the signed current time, nonce, and device information to the server through the interface. The device may then receive an application, a service, or data and a defined period of time from the server through the interface to be available for use for the defined period of time measured by the trusted execution environment.

### BACKGROUND

### Field

The present invention relates to a device to provide trusted time assurance.

### Relevant Background

Today, devices do not have a time clock that is securely set and controlled. This is especially problematic for mobile devices, Internet of Thing (IoT) devices, and Internet of Everything (IoE) devices. Because of this, a user may modify the time clock whenever desired, which is very undesirable for application and service providers and content providers, in general. Most Original Equipment Manufacturers (OEMs) do not want to spend the money on hooking up their systems to a Network Time Service (NTS) or Global Positioning System (GPS) to make sure their device handles time securely. Further, even if they do secure time synchronization on a timely basis—there is no guarantee that the time value used for a specific operation will be correct and/or not modified.

Existing solutions do not work for the following reasons:

1) NTS: Network Time Services are run by independent third parties and can be used to synchronize time on the device. However, this time may be untrustworthy because the implementation of NTS on the device may be faulty or hacked or the operating system (OS) of the device may be hacked.
2) GPS time is untrustworthy—because it may be spoofed or hacked on the device.
3) User settable time: A user may be requested to set date/time combinations. But these techniques are also untrustworthy as the user may not be trustworthy.

Because current time clocks cannot be trusted, many use cases mentioned below are very difficult to implement:

1) Application or Service authentication: Application or Service authentication that relies on a certificate expiration or signature expiration, in which, expired certificates or signatures are not supposed to be used for application or service authentication; and
2) License enforcement: License enforcement that depends on time, in which, a license is time bound and supposed to revoke the service/software/data/content once the time has elapsed.

Therefore, techniques are needed such that a server that provides applications, services, data, etc., to a device can have assurances that the time used by its applications, services, data, etc., running on a device can be trusted.

### SUMMARY

Aspects may relate to a device to provide trusted time assurance. The device may comprise: a time clock; an interface; and a processor coupled to the interface. The processor may be configured to operate a trusted execution environment to: receive a request through the interface from a server to send current time; receive a nonce from the server through the interface; sign the current time from the time clock, the nonce received from the server, and device information with an attestation key; transmit the signed current time, nonce, and device information to the server through the interface. The device may then receive an application, a service, or data and a defined period of time from the server through the interface to be available for use for the defined period of time measured by the trusted execution environment.

### BRIEF DESCRIPTION OF THE DRAWINGS

FIG. 1 is a diagram of a system in which embodiments may be practiced.

FIG. 2 is a diagram of an example of a process to provide trusted time assurance.

FIG. 3 is a diagram of an example of a process to validate a device for trusted time assurance.

FIG. 4 is a diagram of an example of a process to provide trusted time assurance.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, Internet of Everything (IoE) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

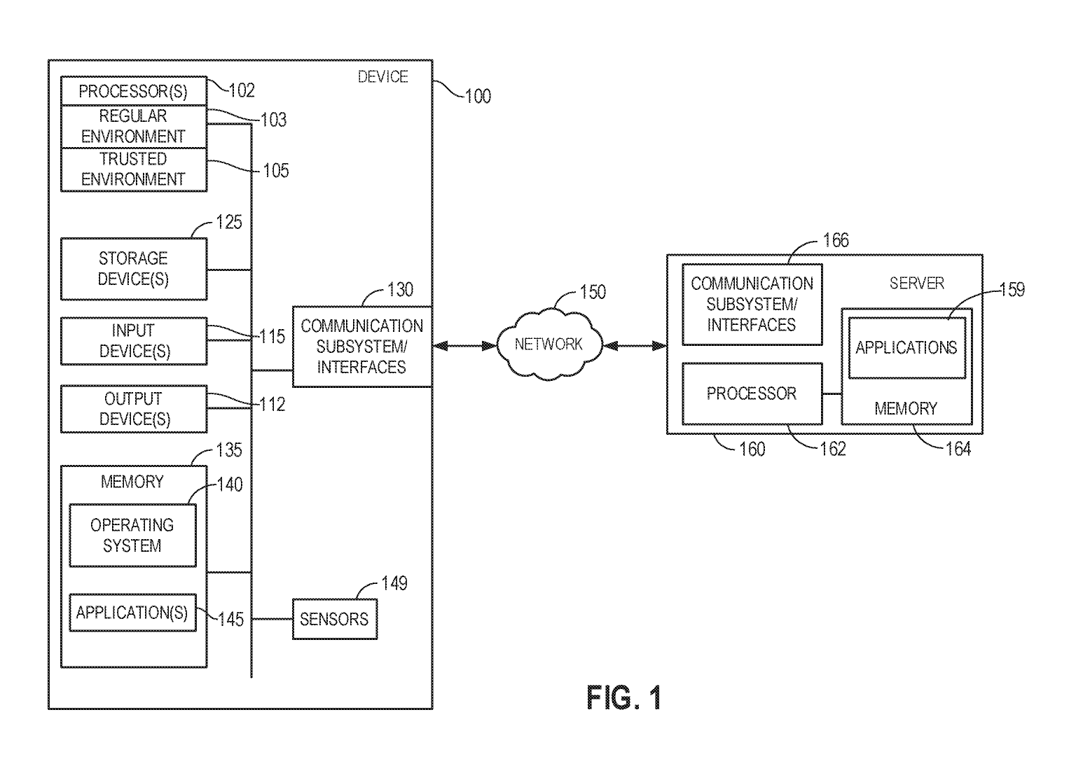

With reference to FIG. 1, as an example, device 100 may be in communication with one or more servers 160, respectively, via a network 150 (e.g., wireless, wired, or a combination thereof). As will be described, each server 160 may be any type of entity (e.g., a company website (i.e., that sells products, services, applications, content, data, etc.), a financial company, a medical service, a network company, a content provider (video, music, etc.), a utility company, a government institution, i.e., any entity). For example, the server 160 may provide applications, services, data, etc.

Device 100 may comprise hardware elements that can be electrically coupled via a bus (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, touchscreen, buttons, microphone, camera, etc.); and one or more output devices 112—such as a display device (e.g., a screen) 113, speaker, sound device, etc. Additionally, device 100 may include a wide variety of sensors 149. Sensors may include: a clock, an ambient light sensor (ALS), a biometric sensor, an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, a biometric sensor, or any type of sensor.

In one embodiment, processor 102 may operate in a regular execution environment 103 and/or a trusted execution environment 105. As will be described, in one embodiment, processor 102 may operate in a trusted execution environment 105 to implement functions to be hereafter described.

Device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communication subsystems and/or interfaces 130 may permit data to be exchanged with servers 160 through an appropriate network 150 (wireless and/or wired).

In some embodiments, device 100 may further comprise a working memory 135, which can include a RAM or ROM device, as described above. Device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed hereafter may be implemented as code and/or instructions executable by a device (and/or a processor within a device); in an aspect, then, such code and/or instructions can be used to configure and/or adapt a device 100 to perform one or more operations in accordance with the described methods, according to embodiments described herein.

A set of these instructions and/or code may be stored on a non-transitory computer-readable storage medium, such as the storage device(s) 125, described above, and/or within other memory 135 locations. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a device with the instructions/code stored thereon.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other devices such as network input/output devices may be employed.

As previously described, device 100 may be any type of device, computer, smartphone, tablet, cellular telephone, watch, wearable device, Internet of Things (IoT) device, or any type of computing device. Further, as has been previously described, device 100 may be in communication via interface 130 through network 150 to server 160. It should be appreciated that server 160 may be a device having at least a processor 162, a memory 164 with one or more applications 159, an interface/communication subsystem 166, as well as other hardware and software components, to implement operations.

Server 160 may be a particular entity that provides applications, services, data, content, etc. For example, server 160 may be a company website that sells products, services, applications, content, data, etc. As other examples, server 160 may be: a financial company, a medical service, a network company, a content provider (video, music, etc.), a utility company, a government institution, i.e., any type of entity. It should be appreciated that server 160 may utilize a processor 162, applications 159, and interface 166 to communicate with devices 100 through network 150 to distribute products, services, applications, content, data, etc.

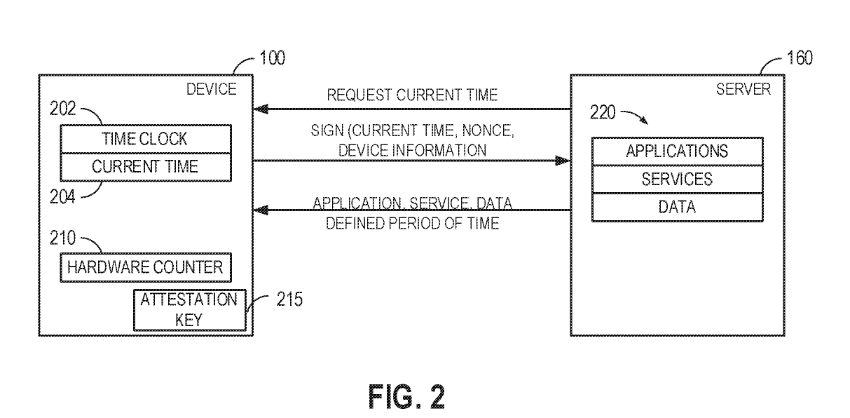

With additional reference to FIG. 2, in one embodiment, device 100 may include a time clock 202 that may generate a current time 204. Time clock 202 may be any sort of suitable time clock. For example time clock 202 may be generated by the operating system and/or a real time clock and/or may be generated based upon a received external time source and/or updates from the received external time source. Therefore, time clock 202 may be updated internally by device 100 and/or may be periodically updated by an external source. As one example, the time clock 202 may be based upon a real time clock and/or may be in communication with other external time sources (e.g., NTS, GPS, etc.) to generate a current time 204 and/or update the current time 204. Further, device 100 may include a hardware counter 210 and an attestation key 215 that will be described in more detail hereafter.

In one embodiment, processor 102 operable in a trusted execution environment 105 coupled through interface 130 may receive a request through the interface 130 from server 160 to send current time 204 and a nonce. This may be based upon device 100 requesting to download an application, a service, or data from server 160 or by server 160 deciding to download an application, a service, or data to device 100. Device 100 under the control of processor 102 may sign the current time from the time clock 202, the nonce received from the server, and device information with an attestation key 215. Device 100 under the control of processor 102 may then transmit the signed current time, the nonce, and the device information to the server 160 through the interface. Based upon this, if authorized by server 160, device 100 may receive an application, a service, or data 220, and a defined period of time from server 160 through the interface to be available for use by the device 100 for the defined period of time as measured by the trusted execution environment of the device. It should be appreciated that the defined period of time may be a pre-set period of time or other period of time defined by the server.

In one embodiment, the hardware counter 210 is in the trusted execution environment in trusted hardware and the defined period of time is measured by the hardware counter 210. As an example, after expiration of the defined period of time, as measured by the hardware counter 210, use of the application, service or data by the trusted execution environment is disabled. Further, as will be described, processor 102 operating in the trusted execution environment may be further configured to: receive periodic requests for attested time for the application, service or data being used by the device 110 from the server 160 and may command the transmission of the attested time to the server 160. The attested time may include the previous current time previously submitted to the server that is combined with the time measured by hardware counter 210. By disabling the application, service, or data based upon the expiration of the defined period of time measured by the hardware counter 210, license enforcement may be provided for server 160. It should be appreciated that the application may be any type of application, program, code, etc., provided by server 160. The service may be any type of service. Also, data may be any type of data such as text, numbers, information, pictures, video, music, graphics, books, etc., (i.e. any type of data or content data). It should be appreciated that the defined period of time may be pre-set period of time or other period of time defined by the server.

In one embodiment, attestation key 215 may include a private key from a public/private key pair that is unique per device or is unique across a set of devices or may be the same public/private key pair provisioned on all devices. For added security, a private key may be protected by hardware such that it is not exposed to software reads at all and software may only use or access it by invoking the hardware. Server 160 may hold the public portion of the key either by itself or in a certificate that could be self-signed or that chains-up to a known trusted root. In some embodiments, attestation key 125 may include a symmetric key (e.g., a shared secret key) that has been shared with the server 160 and is securely programmed onto the device.

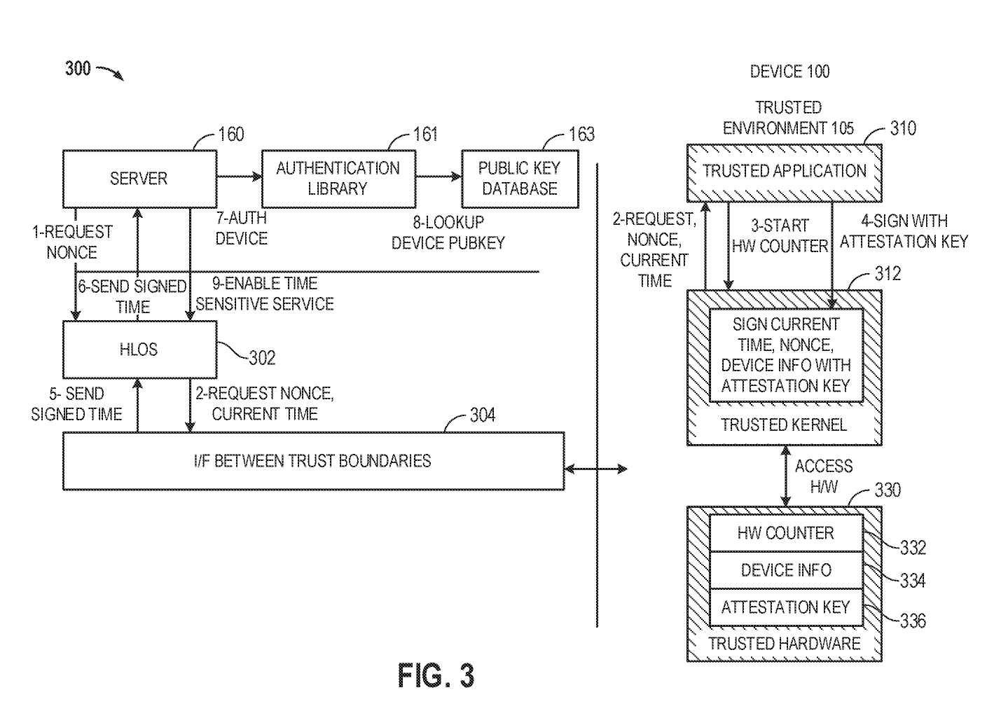

With additional reference to FIG. 3, an example of the process will be further described.

For example, server 160 may at step 1 send a request for current time and a nonce to the high level operating system (HLOS) 302 of device 100. HLOS 302 of device 100 may be operating in regular execution environment (i.e. not in the trusted execution environment). Based upon this, at step 2, HLOS 302 may transmit the request, the nonce, and the current time through an interface (I/F) between trusted boundaries 304 to the trusted execution environment 105 of device 100. As has been previously described, the current time may be generated by time clock 202. Continuing with step 2, trusted kernel 312 operating under the control of the trusted execution environment 105 may pass the request, current time, and nonce to trusted application 310 also operating under the control of the trusted execution environment 105.

Based upon this, trusted application 310, at step 3, requests that trusted kernel 312 start the hardware counter 332, and, at step 4, sign the current time, nonce, and device information with the attestation key 336. In one embodiment, to accomplish this, trusted hardware 330 is accessed. Trusted hardware 330 may include hardware counter 332, device information 334, and attestation key 336. Hardware counter 332 may be a separate secure hardware counter that measures time in seconds, milliseconds, etc. Device information 334 may be unique device identifier for the device and may be securely stored in trusted hardware 330. Attestation key 336 may be a private key of device 100 for use in private/public key validation with server 160 and may be securely stored in trusted hardware 330. As previously described, in some embodiments, attestation key 336 may be a symmetric secret key (e.g., a shared secret key).

Based upon this, the trusted execution environment 105 of device 100 through the I/F between trust boundaries 304, at step 5, may send the signed current time, nonce, and device information through HLOS 302, at step 6, to server 160.

In one embodiment, server 160 may authenticate device 100, step 7, by finding the device identification in an authentication library 161 and by looking up the public key of the device 100 from the public key database 163, step 8. In this way, in the public/private key example, device 100 may be authenticated with the signature by private attestation key 336 and an application, service, or data may be enabled for use by device 100 for a defined period of time. In particular, at step 9, server 160 may transmit an application, a service, or data and a defined period of time for use by device 100 for the defined period of time to be measured by the hardware counter 332 of the trusted exaction environment 115. In this way, device 100 may be allowed to utilize the application, service, or data for the defined period of time as measured by the hardware counter 332, until the expiration of the defined period of time as measured by the hardware counter 332 at which point the application, service, or data is disabled. It should be appreciated that the defined period of time may be pre-set period of time or other period of time defined by the server.

Thus, in one embodiment, as described with reference to FIG. 3, server 160 may ask device 100 to send the signed current time and may verify/authenticate that time. Then, if properly validated, server 160 may then push the time sensitive application, service, data, etc. onto device 100 with a defined period of time. Server 160 can then feel a guarantee that device 100 utilizing trusted hardware counter 332 in a trusted execution environment 105 will enforce the time expiration such that after the expiration of the defined period of time as measured by the trusted hardware counter 332, the application, service, or data will be disabled.

The previously described trusted application 310 and trusted kernel 312 operating in a trusted execution environment 105 implemented by a processor of device 100 is just one example and a plurality of different type of trusted modes may be implemented by a device. For example, device 100 may implement: a trust zone; a secure environment; a secure element; a privileged environment; a privileged mode, etc. Processor 102 to implement these types of trusted execution environments, trust zones, secure environments, privileged environments, may be general processor or may be a specialized processor—e.g., a secure processor, a cryptoprocessor, etc.

Further, as previously described, device 100 may utilize an attestation key 336 that is a private key that is only available to the trusted environment 105. However, in some embodiments, attestation key 336 may be a symmetric key (e.g., a shared secret key). In one example, during the factory device manufacturing process, public keys for all devices may be collected along with device information and this information may be distributed to potential entities (e.g., servers) that may want to utilize this functionality to provide applications, services, data, etc., to devices, as previously described.

Below are a few examples of ways to provide the trusted execution environments 105 of devices 100 with unique asymmetric or private keys. For example, OEMs may provision unique asymmetric or private keys on each device and corresponding public keys and device identifiers (IDs) (e.g. device information) to potential entities (e.g., servers). This example may be utilized with the previous example of utilizing a stored private attestation key 336 and device information 334 stored in trusted hardware 330. As another example, an end-end solution to provision a key based on a seed which can be validated by the server may be utilized. For example, the device's trusted execution environment may generate an asymmetric or private key based on a provided seed. As another example, CRI crypto-module hardware that allows for securely communicating with the device's trusted execution environment may be utilized. This may be based on a key ladder with a root in some public key owned by CRI. As yet another example, an endorsement key (EK) certificate of a trusted platform module may be utilized. Further, as even another example, the attestation key may be for a key master (e.g., an external key master service). It should be appreciated that a wide variety of attestation key implementations may be utilized.

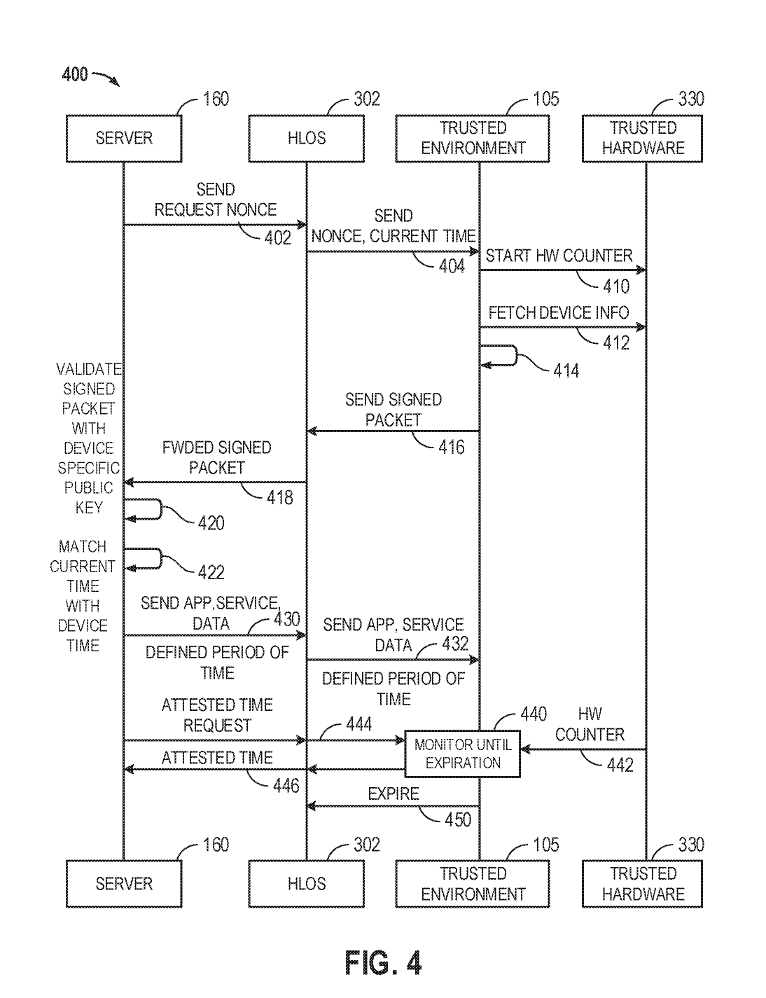

With additional reference to FIG. 4, another example will be provided. If a server 160 would like to upload an application, a service, or data to a device 100 the following steps may occur. At step 402, server 160 may send a request for the current time and a device identifier along with a nonce to the HLOS 302 of device 100. The non-secure HLOS 302 may send the nonce, the request for the device identifier, and the current time, to the trusted execution environment 105 (step 404). The trusted execution environment 105 allows access to the unique private key available to it to sign the nonce, the device information and the current time. Further, at step 410, trusted execution environment 105 starts the hardware counter 332 of trusted hardware 330 and fetches the device information 334 (step 412). At step 414, trusted execution environment 105 signs the current time, device information, and nonce, using the private attestation key 336. The trusted execution environment 105, at step 416, then sends this signed packet to HLOS 302. At step 418, HLOS 302 sends this signed packet to server 160.

It should be appreciated that the hardware counter 332 is used by the trusted execution environment 105 to keep track of the time offset since the signature was created. In this way, the time is measured by the hardware counter 332, and, after expiration of the defined time period measured by the hardware counter, use of the application, service, or data by the trusted execution environment may be disabled in accordance with the defined period of time for use of the application, service, or data specified by server 160.

At step 420, server 160 validates the signed blob (e.g. the signed nonce, the signed device information, and signed current time). In particular, server 160 can validate this packet against the public key for this device. It should be appreciated, that since only the trusted execution environment 105 of device 100 can create this signed message, server 160 has a guarantee that the information is valid and can match the current time with the device time, step 422, such that it has a guarantee as to what time the trusted execution environment 105 of the device 100 will work off of.

Further, in one embodiment, server 160 may send an application, service, or data and a defined period of time to HLOS 302, step 430, which may then be forwarded to the trusted execution environment 105, step 432. Trusted execution environment 105 may monitor the use of the application, service, or data for the defined period of time based upon time measured by hardware counter 332 from trusted hardware 330 (step 442) (monitor until expiration block 440). Thus, hardware counter 332 may measure the defined period of time, and, after expiration of the defined period of time measured by the hardware counter, use of the application, service, or data may expire (step 450) and HLOS 302 may expire/terminate the availability of use of the application, service or data in accordance with the defined period of time set by server 160. It should be appreciated that the defined period of time may be pre-set period of time or other period of time defined by the server.

Also, in some embodiments, server 160, at step 444, may transmit attested time requests to device 100 for the use of the application, service or data being used and, in response, the trusted execution environment 105 utilizing the hardware counter may transmit attested time back to server 160, step 446, which may include the previous current time combined with the time measured by the hardware counter.

Thus, server 160 may transmit applications, services, or data that are available for use by the device 100, for a defined period of time, which is measured by the hardware counter 332 to provide for license enforcement. Further, application or service authentication that relies upon a certificate expiration or signature expiration may be easily utilized. An application or service can be uploaded or downloaded with a defined period of time for expiration and this can be done with the assurance that when it is time for the expiration of the application or service (based upon certificate expiration or signature expiration), device 100 utilizing the hardware counter will ensure that the application or service is disabled. Further, as to license enforcement that depends on time, the license may be time bound and the uploaded service/application/software/data/content/etc. will expire once the time has elapsed. As one particular example, test applications may be uploaded to devices. For example, the test applications may be available for use for the defined time measured by the hardware counter and will then expire after the defined period of time. This may allow developers to do rapid development and testing on devices such that developers do not need to buy custom devices to do their development thereby saving them significant amounts of time and money.

As has been previously described, license enforcement could be provided for any type of application, service, data, etc. In particular, any sort of data such as text, numbers, information, pictures, video, movies, music, graphics, books, etc., (i.e. any type of data or content data) may have a time based license enforced. In this way, content providers may be provided with an assurance that their defined period of time is enforced for digital rights management (DRM). In particular, this is very useful in that many DRM applications are typically utilized in trusted execution environments.

By utilizing the previously described embodiments, a server can provide applications, services, data, etc., and can have assurances that the time used by its applications, services, data, etc., running on a device can be trusted and will expire at the defined period of time set by the server. Further, independent third party types of time counters (e.g. network time service (NTS) and GPS time) that may be hacked or spoofed do not need to be relied upon.

It should be appreciated that aspects of the previously described processes may be implemented in conjunction with the execution of instructions by a processor (e.g., processors 102, 162) of devices (e.g., device 100, server 160), as previously described. Particularly, circuitry of the devices, including but not limited to processors, may operate under the control of a program, routine, or the execution of instructions to execute methods or processes in accordance with embodiments described (e.g., the processes and functions of FIGS. 2-4). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
a time clock;
an interface; and
a processor coupled to the interface, the processor configured to operate a trusted execution environment to:
receive a request through the interface from a server to send current time;
receive a nonce from the server through the interface;
sign the current time from the time clock, the nonce received from the server, and device information with an attestation key;
transmit the signed current time, nonce, and device information to the server through the interface; and
receive an application, a service, or data and a defined period of time from the server through the interface to be available for use for the defined period of time measured by the trusted execution environment.

2. The device of claim 1, further comprising a hardware counter in the trusted execution environment, wherein the defined period of time is measured by the hardware counter.

3. The device of claim 2, wherein, after expiration of the defined period of time measured by the hardware counter, use of the application, service, or data by the trusted execution environment is disabled.

4. The device of claim 3, wherein, the processor is further configured to: receive periodic requests for attested time for the application, service, or data being used from the server and transmit the attested time to the server, wherein the attested time includes the previous current time combined with the time measured by the hardware counter.

5. The device of claim 3, wherein, the application, service, or data available for use for the defined period of time measured by the hardware counter provides for license enforcement.

6. The device of claim 1, wherein, the attestation key includes a private key for use in private/public key validation with the server.

7. The device of claim 1, wherein, the attestation key includes a symmetric key.

8. A method comprising:
receiving a request from a server to send current time and a nonce;
signing the current time from a time clock, the nonce received from the server, and device information with an attestation key in a trusted execution environment;
transmitting the signed current time, nonce, and device information to the server; and
receiving an application, a service, or data and a defined period of time from the server to be available for use for the defined period of time measured within the trusted execution environment.

9. The method of claim 8, wherein, the defined period of time is measured by a hardware counter in the trusted execution environment.

10. The method of claim 9, wherein, after expiration of the defined period of time measured by the hardware counter, use of the application, service, or data by the trusted execution environment is disabled.

11. The method of claim 10, further comprising, receiving periodic requests for attested time for the application, service, or data being used from the server and transmitting the attested time to the server, wherein the attested time includes the previous current time combined with the time measured by the hardware counter.

12. The method of claim 10, wherein the application, service, or data available for use for the defined period of time measured by the hardware counter provides for license enforcement.

13. The method of claim 8, wherein, the attestation key includes a private key for use in private/public key validation with the server.

14. The method of claim 8, wherein, the attestation key includes a symmetric key.

15. A non-transitory computer-readable medium including code that, when executed by a processor operating in a trusted execution environment of a device, causes the processor to:
receive a request from a server to send current time and a nonce;
sign the current time from a time clock, the nonce received from the server, and device information with an attestation key in the trusted execution environment;
transmit the signed current time, nonce, and device information to the server; and
receive an application, a service, or data and a defined period of time from the server to be available for use for the defined period of time measured within the trusted execution environment.

16. The computer-readable medium of claim 15, wherein, the defined period of time is measured by a hardware counter in the trusted execution environment.

17. The computer-readable medium of claim 16, wherein, after expiration of the defined period of time measured by the hardware counter, further comprising code to disable use of the application, service, or data by the trusted execution environment.

18. The computer-readable medium of claim 17, further comprising code to receive periodic requests for attested time for the application, service, or data being used from the server and transmit the attested time to the server, wherein the attested time includes the previous current time combined with the time measured by the hardware counter.

19. The computer-readable medium of claim 17, wherein the application, service, or data available for use for the defined period of time measured by the hardware counter provides for license enforcement.

20. The computer-readable medium of claim 15, wherein, the attestation key includes a private key for use in private/public key validation with the server.
